(19) United States
(12) Patent Application Publication
(10) Pub. No.: US 2023/0112674 A1
(43) Pub. Date: Apr. 13, 2023

(54) EXPLORATORY LANGUAGE-LEARNING SYSTEM BASED ON ML, NLP AND PATTERN-BASED REFERENCE LIBRARY

(71) Applicant: MIRINAE TECHNOLOGIES INC., Seoul (KR)

(72) Inventors: Hwan Soo YOO, Seoul (KR); John WAINWRIGHT, Campbell, CA (US)

(21) Appl. No.: 17/909,511

(22) PCT Filed: Mar. 8, 2021
(86) PCT No.: PCT/KR2021/002856

§ 371 Date: Sep. 6, 2022

(30) Foreign Application Priority Data
Mar. 8, 2020 (US) 62986764
Oct. 21, 2021 (KR) 10-2020-0137119

(51) Int. Cl. G09B 19/06; G06F 40/268; G06F 40/253; G06F 40/284; G06F 40/211; G06F 40/169; G06F 16/903

(52) U.S. Cl. CPC G09B 19/06; G06F 40/268; G06F 40/253; G06F 40/284; G06F 40/211; G06F 40/169; G06F 16/90335

(57) ABSTRACT

An exploratory language-learning system based on ML (Machine Learning), NLP (Natural Language Processing) and a pattern-based reference library including: input means for collecting or inputting instances generated in the language; a morphological analyzer for generating linguistic units, words, stems, affixes, and phonetic symbol input characters and part-of-speech in the sentence input through the input means; a reference library indexed by morphological and syntactic patterns; a lexical pattern matcher that processes the contents processed by the word type analyzer with reference to a reference library; a phrase-structure parser for recognizing larger phrases and clause structures by processing the phrase structure processed by the vocabulary pattern matcher; a library pattern-matcher that processes the syntax structure processed through the phrase-structure parser with reference to the reference library, and a reference explorer that allows users to view and explore related reference materials.

### CROSS REFERENCE

This is a PCT national stage entry of International Application No. PCT/KR2021/002856 claiming priority of U.S. Provisional Application No. 62/986,764 and Korean Patent Application No. 10-2020-0137118, the entirety of which is incorporated herein by reference.

### BACKGROUND

relates to an exploratory language-learning system based on ML (Machine Learning), NLP (Natural Language Processing) and a pattern-based reference library, and more particularly, to a computer-based system designed to be a learning aid for individuals learning a foreign language or native-speaking students of a language. It enables an exploratory, self-guided mode of learning in which encountered instances of the target language are analyzed by the AI (Artificial Intelligence) and natural-language processing components of the system and then mapped automatically to the relevant entries in an associative reference library, allowing the user to explore the parts-of-speech, word-meanings, phrase-structure and grammar and idiom patterns used in that instance of the language.

With the development of Internet services, the number of people who enjoy video content from other countries using personal terminals or electronic devices is increasing.

In particular, under the influence of K(Korean)-pop, in English-speaking countries, not only Korean music videos but also various video contents such as movies are increasingly being watched.

However, for example, when watching a Korean video using a video viewing program such as Viki, which uses English, learning Korean serviced through subtitles or trying to find the English of the corresponding Korean, there is no immediate service available. the current situation.

Prior Art Document: Korean Patent Publication No. 10-1578991 (registered on Dec. 14, 2015).

### SUMMARY OF INVENTION

In consideration of the above-mentioned circumstances, it is an object of the present invention to provide to a computer-based system designed to be a learning aid for individuals learning a foreign language or native-speaking students of a language. It enables an exploratory, self-guided mode of learning in which encountered instances of the target language are analyzed by the AI (Artificial Intelligence) and natural-language processing components of the system and then mapped automatically to the relevant entries in an associative reference library, allowing the user to explore the parts-of-speech, word-meanings, phrase-structure and grammar and idiom patterns used in that instance of the language.

To achieve the above object, according to an aspect of the present invention, there is provided an exploratory language-learning system based on ML, NLP and a pattern-based reference library, the system including: input means for collecting or inputting instances generated in the language;

a morphological analyzer for generating linguistic units, words, stems, affixes, and phonetic symbol input characters and part-of-speech in the sentence input through the input means;

a reference library indexed by morphological and syntactic patterns;

a lexical pattern matcher that processes the contents processed by the word type analyzer with reference to a reference library;

a phrase-structure parser for recognizing larger phrases and clause structures by processing the phrase structure processed by the lexical pattern matcher;

a library pattern-matcher that processes the syntax structure processed through the phrase-structure parser with reference to the reference library, and

a reference explorer that allows users to view and explore related reference materials.

As described above, in accordance with the exploratory language-learning system and method based on ML (Machine Learning), NLP (Natural Language Processing) and a pattern-based reference library, there are advantages as follows. In the present invention, there is provided a computer-based system designed to be a learning aid for individuals learning a foreign language or native-speaking students of a language. It enables an exploratory, self-guided mode of learning in which encountered instances of the target language are analyzed by the AI (Artificial Intelligence) and natural-language processing components of the system and then mapped automatically to the relevant entries in an associative reference library, allowing the user to explore the parts-of-speech, word-meanings, phrase-structure and grammar and idiom patterns used in that instance of the language.

To achieve the above object, according to an aspect of the present invention, there is provided an exploratory language-learning system based on ML, NLP and a pattern-based reference library, the system including: input means for collecting or inputting instances generated in the language;

a morphological analyzer for generating linguistic units, words, stems, affixes, and phonetic symbol input characters and part-of-speech in the sentence input through the input means;

a reference library indexed by morphological and syntactic patterns;

a lexical pattern matcher that processes the contents processed by the word type analyzer with reference to a reference library;

a phrase-structure parser for recognizing larger phrases and clause structures by processing the phrase structure processed by the lexical pattern matcher;

a library pattern-matcher that processes the syntax structure processed through the phrase-structure parser with reference to the reference library, and

a reference explorer that allows users to view and explore related reference materials.

In accordance with another aspect of the present invention, there is provided an exploratory language-learning method based on ML, NLP and a pattern-based reference library, the method including: a first step of confirming that the text to be searched has been input by a user;

a second step that the morpheme analyzer processes the input sentence and generates a breakdown of the sentence;

a third step that various kinds of affixes are isolated and labeled, the stem of a verb is separated, and the appropriate part-of-speech is assigned to every morpheme;

a fourth step in which a pattern-matcher forms an initial “lexical” pass against the morpheme-based pattern of the library;

a fifth step in which the lexical pass generates potential complex morpheme structures such as auxiliary verb patterns,

a sixth step in which syntactic parsing (parsing) is applied to an annotated modified morphological structure;

a seventh step (a parsing step) of identifying larger and possibly overlapping syntax and clause structures; and

an eighth step in which another pass of a pattern-matcher is applied.

In addition, wherein the parsing step is performed using a computer language parsing method such as a standard NLP or chunking grammar or a recursive-descent parser.

In addition, wherein the method comprises patterns for referencing syntactic structures and morpheme structures, attaches different sets of annotations to morphemes and parsing structures, and reconnects the annotation sets to all referenced items in the library for display and navigation in reference searchers.

In addition, wherein the results are presented graphically, in a progressive interactive form, allowing the user to drill-down to the part of the analysis that is most interesting to the user.

### BRIEF DESCRIPTION OF DRAWING

FIG. 1 is a functional explanatory diagram schematically illustrating a learning process in a machine learning, natural language processing, and pattern-based reference library-based search language learning system according to the present invention.

### DETAILED DESCRIPTION OF THE INVENTION

Hereinafter, an exploratory language-learning system and method based on ML, NLP and a pattern-based reference library according to the present invention will be described in detail with reference to the accompanying drawings.

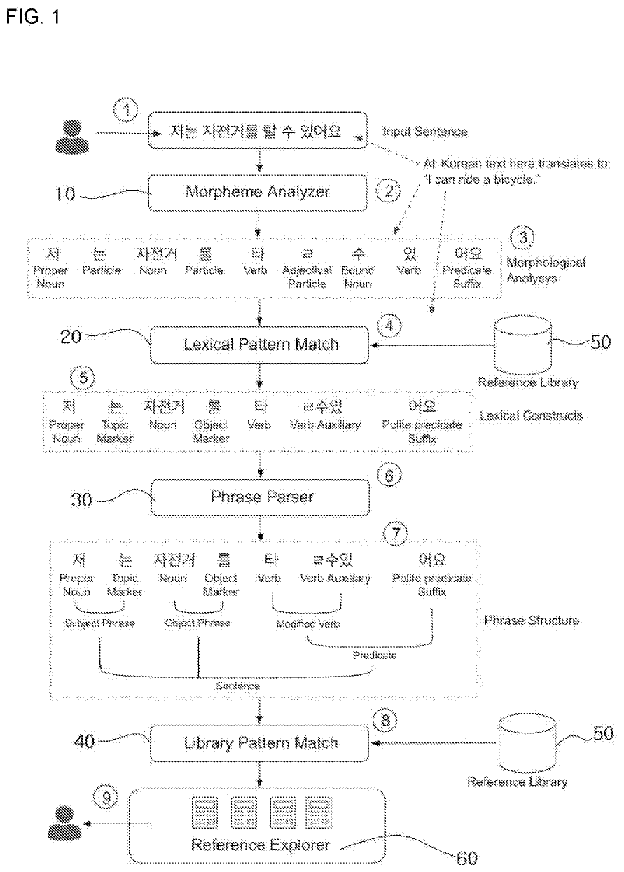

FIG. 1 is a functional explanatory diagram schematically illustrating a learning process in a machine learning, natural language processing, and pattern-based reference library-based search language learning system according to the present invention.

As shown in FIG. 1, the present invention described in this document is a computer-based system designed to be a learning aid for individuals learning a foreign language or native-speaking students of a language. According to the present invention, it enables an exploratory, self-guided mode of learning in which encountered instances of the target language are analyzed by the AI and natural-language processing components of the system and then mapped automatically to the relevant entries in an associative reference library, allowing the user to explore the parts-of-speech, word-meanings, phrase-structure and grammar and idiom patterns used in that instance of the language.

The reference library can contain extensive material for each of these elements in a target language, including usage notes, alternate example uses, links to external reference sites, book citations and so forth. It is structured in such a way that it can be indexed by the morphological and phrasal patterns found by the ML and NLP components, enabling a form of bottom-up learning, in which organically-encountered text drives the learning and discovery process, augmenting the typical top-down approaches of structured courseware and class curriculums.

The invention presented here can be applied to any combination of target and learner languages with appropriately trained analyzers, parsers and library entries, including multiple learner-languages of a particular target language just by replicating reference material in each of the learner languages. Versions of the reference material in the target language itself can be used by native-speakers of the target language in schooling and other educational contexts.

Principles of Operation

One embodiment of this invention comprises the following components; other embodiments are possible as described in the Embodiments section below.

1. An input system for gathering or entering encountered instances of the language

2. A morphological analyzer that produces a morphological reduction of the input text, in terms of the language's linguistic units, words, stems, particles, affixes, diacriticals, etc., and their parts-of-speech

3. A phrase-structure parser that recognizes larger phrasal and clausal structures in the prior morphological reduction

4. A reference library indexed by morphological and phrase-structure patterns

5. A pattern-matching system that finds the reference library entries whose patterns are present in the analysis & parsing of the explored instance

6. A presentation system that allows the user to view and explore the entailed reference material

As shown in FIG. 1, an exploratory language-learning system based on ML, NLP and a pattern-based reference library includes: input means for collecting or inputting instances generated in the language; a morphological analyzer 10 for generating linguistic units, words, stems, affixes, and phonetic symbol input characters and part-of-speech in the sentence input through the input means;

a reference library 50 indexed by morphological and syntactic patterns;

a lexical pattern matcher 20 that processes the contents processed by the word type analyzer with reference to a reference library;

a phrase-structure parser 30 for recognizing larger phrases and clause structures by processing the phrase structure processed by the lexical pattern matcher 20;

a library pattern-matcher 40 that processes the syntax structure parser processed by the phrase-structure parser 30 with reference to the reference library, and

a reference explorer 60 that allows users to view and explore related reference materials.

The input means is a means for enabling the display of a specific language programmatically or hardware in a specific video (streaming or not limited thereto) (device) or a video clip that provides a service for outputting movies, plays, and various images, that is operable in relation to the output of the text screen. However, the present invention is not limited thereto, and it may be an input device that is connected to a device outputting an image separately as an external input device and operates by overlaying text on the image or displaying the text at a specific position on the screen. This input device may be operated in conjunction with the language learning system according to the present invention.

These components operate together as shown in FIG. 1.

In step \textcircled{1}, the user inputs some encountered text they wish to explore. In the example above, the student is learning Korean, and inputs the sentence “I can ride a bicycle” in Korean.

In step \textcircled{2}, the morpheme analyzer processes the input sentence and produces a morphological breakdown of the sentence, shown at \textcircled{3} where affixed particles of various kinds have been separated and labeled, verb stems have been isolated, and all morphemes have been assigned appropriate parts-of-speech. Current morpheme analyzers are generally deep neural networks and this invention admits the use of both existing analyzers or new one's trained specifically for this purpose. This is discussed in more detail in the Morphological Analyzer section below.

In step \textcircled{4}, an initial “lexical” pass of the pattern matcher is made against the morpheme-based patterns in the library. The matched patterns can both annotate and transform the morpheme structure, potentially producing compound morpheme structures, such as the “ [symbol] ” (=can do) auxiliary verb pattern in the example shown at \textcircled{5}. These annotations and transformations are carried through to the reference explorer, but can also be important aids to the phrase-structure parser step that follows.

In step \textcircled{6}, a phrase-structure parsing is applied to the annotated & transformed morphological structure, identifying the larger, possibly nested phrase and clause structures as shown at \textcircled{7}. This parsing step is performed using standard NLP or computer-language parsing approaches, such as chunking grammars or recursive-descent parsers. The current invention admits the use of any of these parsing technologies. Note that some embodiments of this invention may drop steps \textcircled{4} or \textcircled{6}, but not both, without loss of generality.

In step \textcircled{8}, another pass of the pattern-matcher is applied, this time including patterns that reference phrase structures as well as morpheme structures. This attaches another set of annotations to the morpheme and parsing structures, linking them back to all the reference entries in the library, in preparation for display & exploration in the reference explorer.

In \textcircled{9}, the results of all the analysis and pattern matching are made available for review by the user. In one embodiment of this invention, the results are presented in graphical, incremental, interactive form, allowing the user to drill-down into the parts of the analysis that are of most interest. The presentation system may store the analyses and exploration states of any or all of the entered text for later continued study by the user.

In another embodiment, some elements of the analysis may have long latencies (such as translations or word lookups on external services), in which case the full analysis may be delivered in parts to the display system at \textcircled{9}, with low-latency elements delivered for immediate display, and longer-latency elements delivered asynchronously and become displayable as they are available.

### Embodiments

The various elements of this invention may exist in a number of embodiments; the discussion below presents some of them in more detail.

Morphological Analyzer

The morphological analyzer performs a task that is well-known in the natural-language processing field and for which there are a number of implementation approaches. The most-popular approach currently is to use deep neural-net models trained on corpuses of existing morphological parsings. There are extant models available for various languages, or new one's can be trained.

Most morphological analyzers are not perfect. The current state of the art for CNN-based analyzers is in the 97% to 98% range, so error-correction or accomodation schemes should generally be employed. In this invention, encountered morphological analysis errors can be captured as transforming patterns in the pattern library and so this kind of error correction becomes a normal part of the morphology-structure transformations carried out in step in the operational outline above.

This invention is not adding to the existing art of morphological analyzer construction, but using state-of-the-art analyzers in a novel approach to language learning.

Phrase-Structure Parser

In a way similar to the morphological analyzer component, phrase-structure parsing is a well-known element of natural-language processing and computer language implementation, and any of the common approaches can be used to implement this component, such as chunking grammars, declarative parser-generators, or ad-hoc recursive-descent parsers.

Ad-hoc recursive-descent parsers, in the context of natural-language parsing, have the advantage of admitting context-sensitive parsings which may be required for some grammars.

It is also possible to train neural-net based analyzers to recognize and output both morphological destructurings and phrase structuring, given training data that encodes both.

Note that an extensive and complete phrase-structure parsing is not essential in this application, as the parsings have primarily a didactic purpose, and often simpler, coarse structurings are easier for students to understand. The other purpose is to aid in grammar or idiom pattern-recognition, and so only phrase-structures essential for that purpose need to be able to be recognized by the parser.

Pattern-Based Reference Library

The pattern-based reference library is a key component in this invention, and has several aspects and possible embodiments which are novel in the context of this invention and worthy of explication.

Pattern Schemes

Structures in the text under study are associated with transforming or explanatory entries in the library by way of distinguishing patterns in the morphological and phrase structures in that text. The definition and matching of these patterns is a key mechanism in this invention and it admits any scheme that reliably and efficiently achieves this.

One embodiment encodes the morphological structure of some text as a single string and the patterns in the library entries are expressed as regular-expressions over the tokens in that string. For example, the morpheme structure in the sample Korean sentence in the diagram above (=“I can ride a bicycle”) could be represented as:

; [symbol] :NP; [symbol] :JX; [symbol] :NNG; [symbol] :JKO; [symbol] :VV; [symbol] :ETM; [symbol] :NNB; [symbol] :VV; [symbol] :EF; a semicolon-separated sequence of morpheme+part-of-speech pairs, where the parts-of-speech are the common tag codes used in NLP; NP=proper noun, NNG=general noun, VV=verb, etc.

Then a generalized pattern to recognize the [symbol] form could be the regular expression:

((\hat{ }:+):VA-Z+) ( [symbol] ):ETM; [symbol] :NNB; [symbol] :VV

matching any verb followed by either [symbol] or [symbol] particles followed by the bound-noun [symbol] and any conjugation of the auxiliary-verb [symbol] .

As the pattern library grows in number, sequential testing of all the patterns might become computationally prohibitive and so search optimization would be in order. One straightforward embodiment of an optimization would be a trie-coding of all the patterns on common-prefixes.

Guided- and Sample-Trained Patterns

The patterns distinguishing each construct of pedagogic worth in the target language can be constructed in several ways. In one embodiment, the patterns are hand-coded by experts in the grammar and teaching of the target language. In another, the experts use examples of text containing instances of the specific pattern and guide the learning of that pattern. In yet another embodiment, many examples of text containing instances of the patterns are used to train a neural-net-based regular-expression generator for the patterns.

Direct Neural-Net Structure Recognition

Pedagogical structures in the original sentence could also be directly found by a specially-trained neural-network in yet another embodiment of the reference library indexing scheme. In this case, the training data is a corpus of text component sentences labeled with direct links to the reference library entries. A two-phased approach is also possible, in which a guided or manual set of patterns are used to generate a large corpus labeled with library entry indexes, producing a trained neural-net that could be substantially more performant than a search over a large set of regular-expressions.

Multiple Learner Languages

The morpheme analyzer, phrase parser and pattern-set are specific to each target language (language being learned) and are developed once for that language. One embodiment of the reference library structures it in such a way that all explanations, labeling and translations are vectors, partitioned by learner language (native or fluent language of the student) so that the same library and target-language components can readily support multiple learner languages.

Idiom and Sentence Patterns as Well as Formal Grammar

The reference library in some embodiments of this invention would contain most or all of the useful standard lexical, syntactic and grammatical constructs in the target language. In other embodiments the library would be extended to contain patterns and explanations for idiomatic or slang phrases, since the presence of these forms in encountered instances of a language is a common source of difficulty for language learners. The same mechanisms used to define, recognize and explain grammar patterns can be used for idiomatic forms.

There are also usually well-known equivalents of sentence-level patterns of common expressions between any two languages. For example, the common form “I hope X”, such as “I hope you can come”, in English has the equivalent common literal form “If X, it will be good” in Korean. Such sentence-level patterns can also be defined and recognized by the mechanisms in this invention and so will also be added to the reference library in some embodiments

### NLP-Discovered Example Uses

A particularly useful didactic element in a learning tool such as that described here is the provision of many examples of the use of a construct under study. One embodiment of this system will use the pattern definitions to discover such examples automatically in an existing corpus in the target language.

External References

Another useful element in a network-connected embodiment of this invention is the provision of links within reference library entries to external sources of additional teaching or background information. This would include links to related pages on traditional learning sites, or Youtube videos or online reference books or cultural or historical sites. An embodiment of this invention supporting external references would include these kinds of links and any other citations that may be deemed useful.

Crowd-Sourcing

The construction of a reference library containing the standard lexical, syntactic and grammatical constructs in a language is a relatively bounded exercise, similar to that required to create a grammar textbook for the language. Extending that library to contain other material such as idioms, slang, sentence patterns, extensive examples and external reference links is a larger job that can be incrementally implemented over time.

Possible embodiments of this invention would include a crowd-sourcing system that invites contributions to the library from any user, with the typical crowd-sourcing controls on quality and content found in other crowd-sourced content services such as Wikipedia or Wiktionary. An intermediate embodiment of this idea would include a general open-text user-feedback system, reviewed and curated by the service's language-teaching experts to extract and enter useful updates to the library.

Crowd-sourcing techniques would also be used in an embodiment of this invention to source the learner-language reference material translations mentioned in the multiple learner languages section above.

This invention has been described in its presently contemplated best mode, and it is clear that it is susceptible to numerous modifications, modes and embodiments within the ability of those skilled in the art and without the exercise of the inventive faculty. Accordingly, the scope of this invention is defined by the scope of the following claims.

### INDUSTRIAL APPLICABILITY

As described above, in accordance with the exploratory language-learning system and method based on ML (Machine Learning), NLP (Natural Language Processing) and a pattern-based reference library, there are advantages as follows. In the present invention, there is provided a computer-based system designed to be a learning aid for individuals learning a foreign language or native-speaking students of a language. It enables an exploratory, self-guided mode of learning in which encountered instances of the target language are analyzed by the AI (Artificial Intelligence) and natural-language processing components of the system and then mapped automatically to the relevant entries in an associative reference library, allowing the user to explore the parts-of-speech, word-meanings, phrase-structure and grammar and idiom patterns used in that instance of the language.

1. An exploratory language-learning system based on ML (Machine Learning), NLP (Natural Language Processing) and a pattern-based reference library including:
input means for collecting or inputting instances generated in the language;
a morphological analyzer for generating linguistic units, words, stems, affixes, and phonetic symbol input characters and part-of-speech in the sentence input through the input means;
a reference library indexed by morphological and syntactic patterns;
a lexical pattern matcher that processes the contents processed by the word type analyzer with reference to a reference library;
a phrase-structure parser for recognizing larger phrases and clause structures by processing the phrase structure processed by the vocabulary pattern matcher;
a library pattern-matcher that processes the syntax structure processed through the phrase-structure parser with reference to the reference library, and
a reference explorer that allows users to view and explore related reference materials,
wherein a user searches a part of speech, the meaning of a word, the structure of a sentence, grammar and the pattern of an idiomatic phrase used in the corresponding language instance, and the result is provided with a gradual and interactive type in graphic, so that the user can be drilled-down to the most interesting analysis part.

2. An exploratory language-learning method based on ML (Machine Learning), NLP (Natural Language Processing) and a pattern-based reference library including:
a first step of confirming that the text to be searched has been input by a user;
a second step that the morpheme analyzer processes the input sentence and generates a breakdown of the sentence;
a third step that various kinds of affixes are isolated and labeled, the stem of a verb is separated, and the appropriate part-of-speech is assigned to every morpheme;
a fourth step in which a pattern-matcher forms an initial “lexical” pass against the morpheme-based pattern of the library;
a fifth step in which the lexical pass generates potential complex morpheme structures such as auxiliary verb patterns;
a sixth step in which syntactic parsing (parsing) is applied to an annotated modified morphological structure;
a seventh step (a parsing step) of identifying larger and possibly overlapping syntax and clause structures; and
an eighth step in which another pass of a pattern-matcher is applied,
wherein a user searches a part of speech, the meaning of a word, the structure of a sentence, grammar and the pattern of an idiomatic phrase used in the corresponding language instance.

3. The exploratory language-learning method according to claim 2, wherein the parsing step is performed using a computer language parsing method such as a standard NLP or chunking grammar or a recursive-descent parser.

4. The exploratory language-learning method according to claim 2, wherein the method comprises patterns for referencing syntactic structures and morpheme structures, attaches different sets of annotations to morphemes and parsing structures, and reconnects the annotation sets to all referenced items in the library for display and navigation in reference searchers.

5. The exploratory language-learning method according to claim 2, wherein the results are presented graphically, in a progressive interactive form, allowing the user to drill-down to the part of the analysis that is most interesting to the user.
